(19) United States
(12) Patent Application Publication
(10) Pub. No.: US 2017/0231409 A1
(43) Pub. Date: Aug. 17, 2017

(54) STITCHLESS BEDDING METHOD AND SYSTEM

(71) Applicant: Arun Agarwal, Dallas, TX (US)

(72) Inventor: Arun Agarwal, Dallas, TX (US)

(21) Appl. No.: 15/044,126

(22) Filed: Feb. 16, 2016

(51) Int. Cl. A47G 9/02; B32B 37/10; B32B 37/06; B32B 7/12; B32B 5/02

(52) U.S. Cl. CPC A47G 9/0246; A47G 9/0253; B32B 7/12; B32B 5/02; B32B 37/06; B32B 37/10

(57) ABSTRACT

Disclosed are a method and/or a system of stitchless bedding. In one aspect, a bedsheet component includes a fabric having an angled corner area. A marginal border is folded to include a top marginal fold and a bottom marginal fold. The top marginal fold is aligned to be substantially parallel with the bottom marginal fold. An adhesive is inserted between the top marginal fold and the bottom marginal fold. A heat and/or a pressure is applied to the top marginal fold and/or the bottom marginal fold to soften the adhesive. The adhesive further permeates a portion of the top marginal fold and a portion of the bottom marginal fold. The top marginal fold and the bottom marginal fold are held together as a single, complete flexible unit when the adhesive is cured.

### FIELD OF TECHNOLOGY

This disclosure relates generally to bed dressings and more particularly to a method and/or system of stitchless bedding.

### BACKGROUND

A bedsheet set may include a flat sheet, a fitted sheet, and/or pillowcases. Edges of the bedsheet are folded and stitched together using a sewing needle and/or by thread. Stitched edges of the bedsheet may be unsightly because threads of the bedsheet may be visible and/or occasionally tear apart. Further, stitched edges may cause the bedsheet to wrinkle and/or form uncomfortable lumps and clusters in the bedsheet. In addition, stitches may diminish a visual appearance of the bedsheet by modifying texture, feel, and/or condition of the bedsheet.

Moreover, stitching may lead to puckering (e.g., where the fabric wrinkles and gathers into small folds due to being sewn by thread), leading to unappealing aesthetics and/or user discomfort. Stitched edges may also result in reduced durability. For example, thread may weaken and/or come apart during washing. Stitched edges of the bedsheet may further result in broken needles left in the bedsheet, which may create product liability risk when customers are injured by needles hurting their bodies. Therefore, stitched bedsheets may be unsightly, uncomfortable, and/or dangerous.

### SUMMARY

Disclosed are a method and/or a system of stitchless bedding. In one aspect, a bedsheet component includes a fabric having an angled corner area. A marginal border is folded to include a top marginal fold and a bottom marginal fold. The top marginal fold is aligned to be substantially parallel with the bottom marginal fold. The bedsheet component further includes an adhesive inserted between the top marginal fold and the bottom marginal fold. A heat and/or a pressure is applied to the top marginal fold and/or the bottom marginal fold to soften the adhesive. The adhesive further permeates a portion of the top marginal fold and a portion of the bottom marginal fold. The top marginal fold and the bottom marginal fold are held together as a single, complete flexible unit when the adhesive is cured.

The fabric may have a fabric length and/or a fabric width substantially compatible with a mattress length and/or a mattress width of a conventional mattress. The fabric may be a fitted sheet, a flat sheet, and/or a pillowcase. The marginal border of the bedsheet component may be stitchlessly fastened together through the adhesive when the adhesive is applied in the portion of the top marginal fold and/or the portion of the bottom marginal fold and the adhesive may be cured. The adhesive may be a layer of freely flexible thermoplastic adhesive.

The folding of the marginal border may be by a customized fusion machine. The customized fusion machine may have a worktable surface. The worktable surface may have a surface length substantially compatible with a border length of the marginal border. The marginal border may fit flatly on the worktable surface. The application of the heat and/or the pressure to the top marginal fold and/or the bottom marginal fold may be by a customized fusion machine. The customized fusion machine may have a worktable surface. The worktable surface may have a surface length substantially compatible with a border length of the marginal border.

The marginal border may fit flatly on the worktable surface. The folding of the marginal border and/or the application of the heat and/or the pressure to the top marginal fold and/or the bottom marginal fold may be by a customized fusion machine. The customized fusion machine may have a worktable surface. The worktable surface has a surface length substantially compatible with a border length of the marginal border. The marginal border may fit flatly on the worktable surface. The single, complete flexible unit may be an unencumbered continuous smooth texture. The adhesive may permanently bond the top marginal fold and/or the bottom marginal fold when the adhesive is cured.

In another aspect, a bedsheet component includes a single uniform, substantially rectangular flat sheet of fabric having a right angle corner area and having a fabric length and a fabric width substantially compatible with a mattress length and a mattress width of a conventional mattress. The bedsheet component further includes a marginal border. The marginal border is folded to further include a top marginal fold and a bottom marginal fold. The top marginal fold is aligned to be substantially parallel with the bottom marginal fold.

The bedsheet component further includes a layer of freely flexible thermoplastic adhesive inserted between the top marginal fold and the bottom marginal fold. A heat and/or a pressure to the top marginal fold and/or the bottom marginal fold is applied to soften the layer of freely flexible thermoplastic adhesive. The layer of freely flexible thermoplastic adhesive further permeates a portion of the top marginal fold and a portion of the bottom marginal fold. The top marginal fold and the bottom marginal fold are held together as a single, complete flexible unit when the layer of freely flexible thermoplastic adhesive is cured.

The marginal border of the bedsheet is stitchlessly fastened together through the layer of freely flexible thermoplastic adhesive when the layer of freely flexible thermoplastic adhesive is applied in the portion of the top marginal fold and the portion of the bottom marginal fold and is cured. The layer of freely flexible thermoplastic adhesive may permanently bond the top marginal fold and/or the bottom marginal fold when the layer of freely flexible thermoplastic adhesive is cured.

In yet another aspect, a method of fabricating a bedsheet component includes cutting a single uniform, substantially rectangular flat sheet of fabric having a right angle corner area and having a fabric length and a fabric width substantially compatible with a mattress length and a mattress width of a conventional mattress. A marginal border of the bedsheet is folded. A top marginal fold and a bottom marginal fold are formed when the marginal border of the bedsheet is folded. The top marginal fold is aligned to be substantially parallel with the bottom marginal fold.

A layer of freely flexible thermoplastic adhesive is inserted between the top marginal fold and the bottom marginal fold. A heat and/or a pressure is applied to the top marginal fold and/or the bottom marginal fold to soften the layer of freely flexible thermoplastic adhesive. A portion of the top marginal fold and a portion of the bottom marginal fold are permeated with the layer of freely flexible thermoplastic adhesive. The layer of freely flexible thermoplastic adhesive is cured to stitchlessly fasten the top marginal fold and the bottom marginal fold together as a single, complete flexible unit.

The method of fabricating a bedsheet component may further include stitchlessly fastening together the marginal border of the bedsheet through the layer of freely flexible thermoplastic adhesive when the layer of freely flexible thermoplastic adhesive is applied in the portion of the top marginal fold and/or the portion of the bottom marginal fold and/or the layer of freely flexible thermoplastic adhesive may be cured.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a bedsheet component view of a stitchless bedding system, according to one embodiment.

FIG. 2A is a conceptual view illustrating a marginal border of the bedsheet component of FIG. 1, according to one embodiment.

FIG. 2B is a folded view of the bedsheet component of FIG. 1, according to one embodiment.

FIG. 2C is a folded cross-section view of the bedsheet component of FIG. 1, according to one embodiment.

FIG. 2D is a permeation view of the bedsheet component of FIG. 1, according to one embodiment.

FIG. 3 is a perspective view of the bedsheet component of FIG. 1 illustrating dimensions of a fabric and a conventional mattress, according to one embodiment.

FIG. 4 is a block diagram illustrating the formation of a single and complete flexible unit, according to one embodiment.

FIG. 5 is a critical path view illustrating a flow where the adhesive permeates a portion of the top marginal fold and a portion of the bottom marginal fold of FIG. 2D, according to one embodiment.

FIG. 6 is a process flow detailing the operations involved in fabricating a bedsheet component of FIG. 1, according to one embodiment.

Other features of the present embodiments will be apparent from the accompanying drawings and from the detailed description that follows.

### DETAILED DESCRIPTION

Example embodiments, as described below, may be used to provide a method and/or a system of stitchless bedding. Although, the present embodiments have been described with reference to specific example embodiments, it will be evident that various modifications and changes may be made to these embodiments without departing from the broader spirit and scope of the various embodiments.

In one embodiment, a bedsheet component 100 includes a fabric 102 having an angled corner area 104. A marginal border 106 is folded to further include a top marginal fold 202 and a bottom marginal fold 204. The top marginal fold 202 is aligned to be substantially parallel with the bottom marginal fold 204. The bedsheet component 100 further includes an adhesive 206 inserted between the top marginal fold 202 and the bottom marginal fold 204.

A heat 208 and/or a pressure 210 is applied to the top marginal fold 202 and/or the bottom marginal fold 204 to soften the adhesive 206 (e.g., a layer of freely flexible thermoplastic adhesive). The adhesive 206 further permeates a portion of the top marginal fold 214 and a portion of the bottom marginal fold 216. The top marginal fold 202 and the bottom marginal fold 204 are held together as a single and complete flexible unit 218 when the adhesive 206 (e.g., a layer of freely flexible thermoplastic adhesive) is cured, according to one embodiment.

The fabric 102 may have a fabric length 300 and/or a fabric width 302 substantially compatible with a mattress length 304 and/or a mattress width 306 of a conventional mattress 308. The fabric 102 may be a fitted sheet, a flat sheet, and/or a pillowcase. The marginal border 106 of the bedsheet component 100 may be stitchlessly fastened together through the adhesive 206 when the adhesive 206 is applied in the portion of the top marginal fold 214 and/or the portion of the bottom marginal fold 216 and the adhesive 206 may be cured. The adhesive 206 may be a layer of freely flexible thermoplastic adhesive.

The folding (e.g., fold 400) of the marginal border 106 may be by a customized fusion machine 212. The customized fusion machine 212 may have a worktable surface 402. The worktable surface 402 may have a surface length 404 substantially compatible with a border length 406 of the marginal border 106. The marginal border 106 may fit flatly on the worktable surface 402. The application of the heat 208 and/or the pressure 210 to the top marginal fold 202 and/or the bottom marginal fold 204 may be by a customized fusion machine 212. The customized fusion machine 212 may have a worktable surface 402. The worktable surface 402 may have a surface length 404 substantially compatible with a border length 406 of the marginal border 106.

The marginal border 106 may fit flatly on the worktable surface 402. The folding of the marginal border 106 and/or the application of the heat 208 and/or the pressure 210 to the top marginal fold 202 and/or the bottom marginal fold 204 may be by a customized fusion machine 212. The customized fusion machine 212 may have a worktable surface 402. The worktable surface 402 has a surface length 404 substantially compatible with a border length 406 of the marginal border 106. The marginal border 106 may fit flatly on the worktable surface 402. The single and complete flexible unit 218 may be an unencumbered continuous smooth texture. The adhesive 206 (e.g., layer of freely flexible thermoplastic adhesive) may permanently bond the top marginal fold 202 and/or the bottom marginal fold 204 when the adhesive 206 is cured.

In another embodiment, a bedsheet component 100 includes a single uniform, substantially rectangular flat sheet of fabric 102 having a right angle corner area (e.g., angled corner area 104) and having a fabric length 300 and a fabric width 302 substantially compatible with a mattress length 304 and a mattress width 306 of a conventional mattress 308. The bedsheet component 100 further includes a marginal border 106. The marginal border 106 is folded to further include a top marginal fold 202 and a bottom marginal fold 204. The top marginal fold 202 is aligned to be substantially parallel with the bottom marginal fold 204.

The bedsheet component 100 further includes a layer of freely flexible thermoplastic adhesive (e.g., adhesive 206) inserted between the top marginal fold 202 and the bottom marginal fold 204. A heat 208 and/or a pressure 210 to the top marginal fold 202 and/or the bottom marginal fold 204 is applied to soften the layer of freely flexible thermoplastic adhesive (e.g., adhesive 206). The layer of freely flexible thermoplastic adhesive (e.g., adhesive 206) further permeates a portion of the top marginal fold 214 and a portion of the bottom marginal fold 216. The top marginal fold 202 and the bottom marginal fold 204 are held together as a single and complete flexible unit 218 when the layer of freely flexible thermoplastic adhesive (e.g., adhesive 206) is cured.

The marginal border 106 of the bedsheet is stitchlessly fastened together through the layer of freely flexible thermoplastic adhesive (e.g., adhesive 206) when the layer of freely flexible thermoplastic adhesive is applied in the portion of the top marginal fold 214 and the portion of the bottom marginal fold 216 and is cured. The layer of freely flexible thermoplastic adhesive (e.g., adhesive 206) may permanently bond the top marginal fold 202 and/or the bottom marginal fold 204 when the layer of freely flexible thermoplastic adhesive is cured.

In yet another embodiment, a method of fabricating a bedsheet component 100 includes cutting a single uniform, substantially rectangular flat sheet of fabric 102 having a right angle corner area (e.g., angled corner area 104) and having a fabric length 300 and a fabric width 302 substantially compatible with a mattress length 304 and a mattress width 306 of a conventional mattress 308. A marginal border 106 of the bedsheet is folded. A top marginal fold 202 and a bottom marginal fold 204 are formed when the marginal border 106 of the bedsheet is folded. The top marginal fold 202 is aligned to be substantially parallel with the bottom marginal fold 204.

A layer of freely flexible thermoplastic adhesive is inserted between the top marginal fold 202 and the bottom marginal fold 204. A heat 208 and/or a pressure 210 is applied to the top marginal fold 202 and/or the bottom marginal fold 204 to soften the layer of freely flexible thermoplastic adhesive (e.g., adhesive 206). A portion of the top marginal fold 202 and a portion of the bottom marginal fold 204 is permeated with the layer of freely flexible thermoplastic adhesive (e.g., adhesive 206). The layer of freely flexible thermoplastic adhesive is cured to stitchlessly fasten the top marginal fold 202 and the bottom marginal fold 204 together as a single and complete flexible unit 218.

The method of fabricating a bedsheet component 100 may further include stitchlessly fastening together the marginal border 106 of the bedsheet (e.g., bedsheet component 100) through the layer of freely flexible thermoplastic adhesive (e.g., adhesive 206) when the layer of freely flexible thermoplastic adhesive is applied in the portion of the top marginal fold 214 and/or the portion of the bottom marginal fold 216 and/or the layer of freely flexible thermoplastic adhesive (e.g., adhesive 206) may be cured.

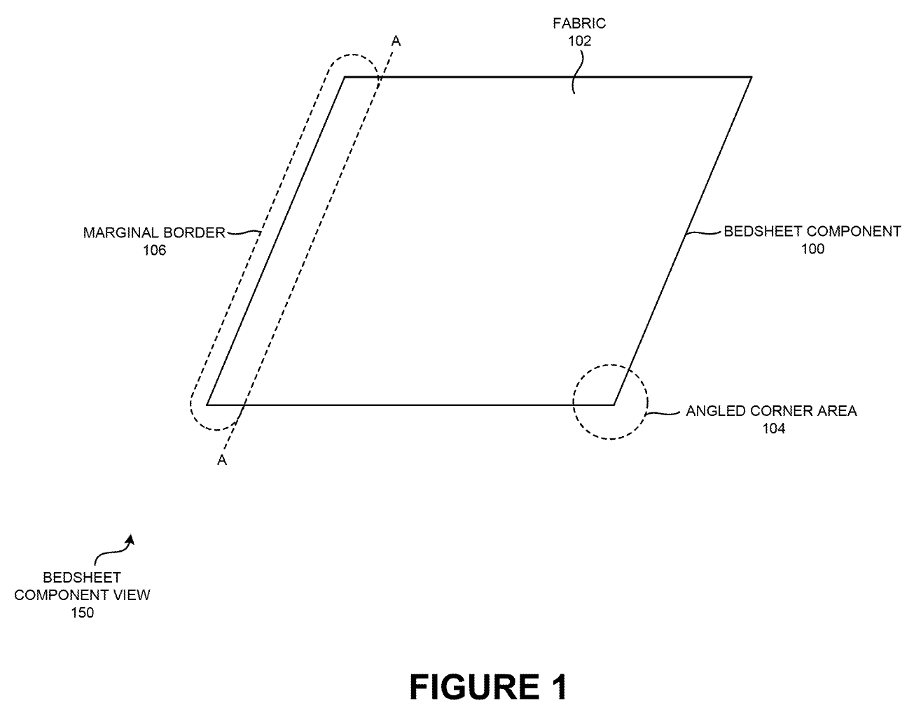

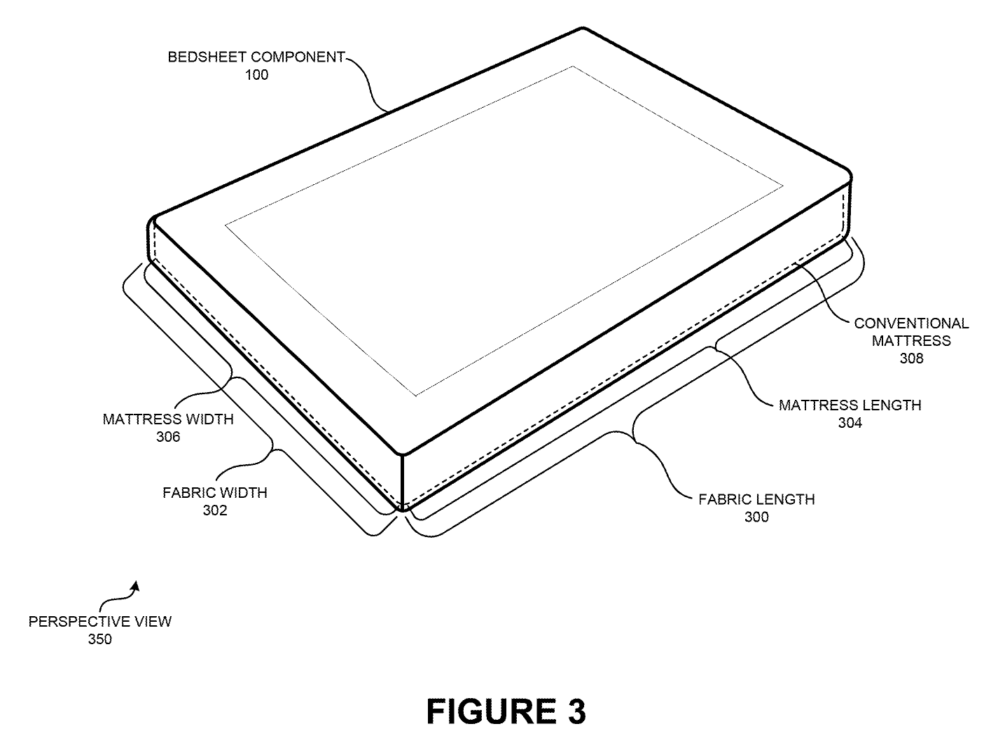

FIG. 1 is a bedsheet component view 150 of a stitchless bedding system, according to one embodiment. Particularly, FIG. 1 illustrates a bedsheet component 100, a fabric 102, an angled corner area 104, and a marginal border 106, according to one embodiment. The bedsheet component 100 may be a single uniform and/or rectangular flat sheet of fabric 102. In another embodiment, the bedsheet component 100 may be a piece of cloth that is used to cover a conventional mattress 308 (as described in FIG. 3). In yet another embodiment, the flat sheet may be referred as a top sheet placed on the top of the fitted sheet and is tucked around the conventional mattress 308 (as described in FIG. 3) at the sides and/or the bottom.

The fabric 102 may be a cloth produced by knitting, weaving, and/or felting natural or synthetic fibers. In another embodiment, the fabric 102 may be a manufactured assembly of interlacing fibers, filaments, and/or yarns. In yet another embodiment, the fabric 102 may be a flexible artificial material that is made by a network of natural and/or artificial fibers. The fabric 102 may be a fitted sheet, a flat sheet, and/or a pillow case. The fitted sheet may be a sheet tailored to fit a particular mattress (e.g., the conventional mattress 308). The flat sheet may be an ordinary sheet for a bed and/or may lie over the fitted sheet. The fabric 102 has a fabric length 300 and a fabric width 302 substantially compatible with a mattress length 304 and mattress width 306 of a conventional mattress 308 (as described in FIG. 3).

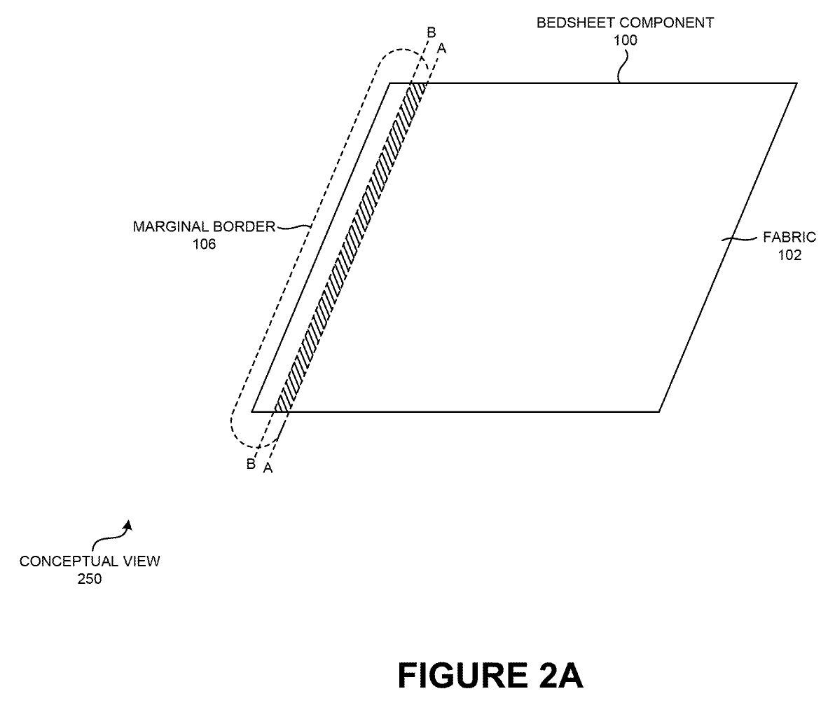

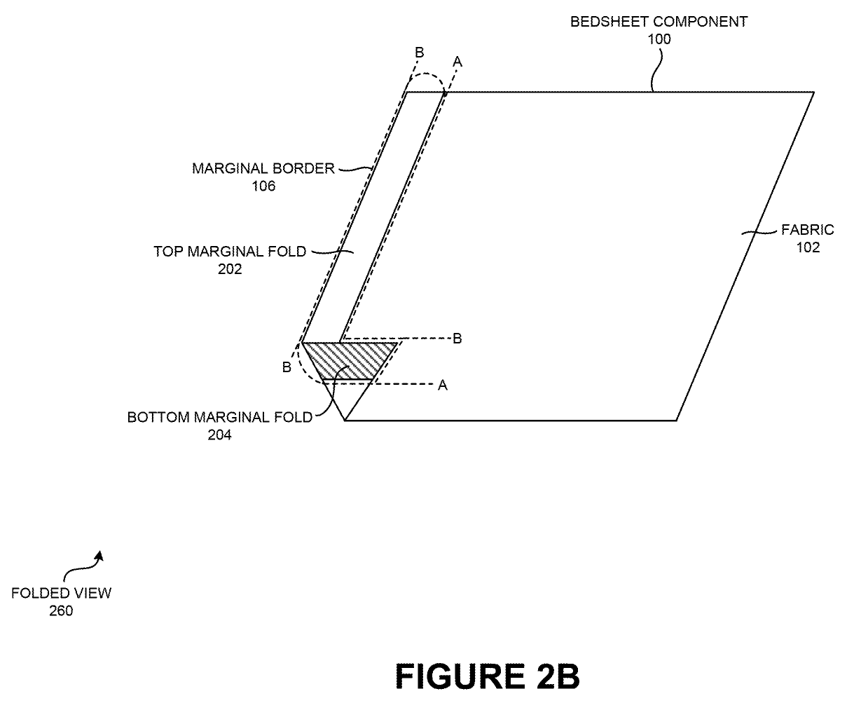

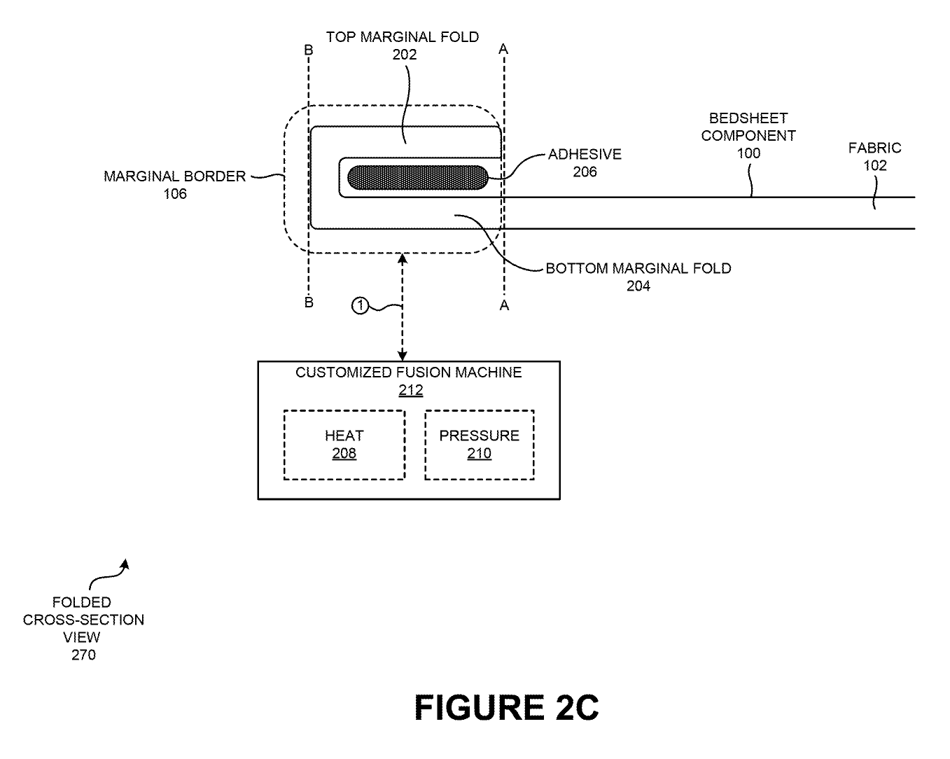

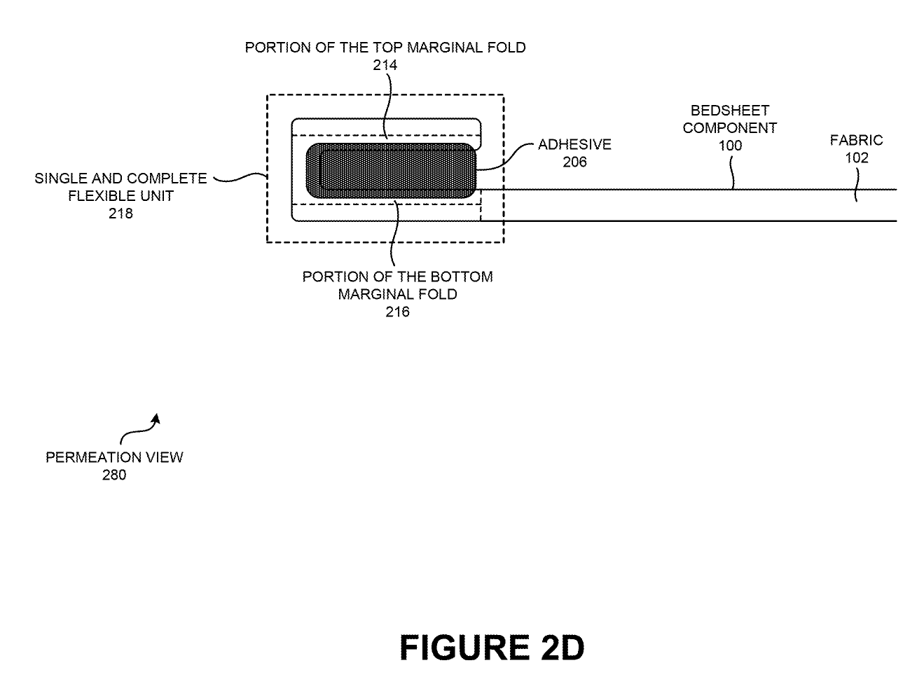

The angled corner area 104 may be a region where two edges (of marginal border(s) 106) of the bedsheet component 100 meet. The marginal border 106 may constitute an edge and/or a boundary of the bedsheet component 100. The marginal border 106 is folded to include a top marginal fold 202 and a bottom marginal fold 204 as described in FIG. 2). The marginal border 106 of bedsheet component 100 is stitchlessly fastened together through an adhesive 206 (as described in FIG. 2).

FIG. 1 illustrates section AA indicating the marginal border 106, according to one embodiment.

FIG. 2A is a conceptual view 250 illustrating the marginal border 106 of FIG. 1, according to one embodiment. Particularly, section AA further indicates a top marginal border of the marginal border 106, according to one embodiment. In addition, section BB indicates a bottom marginal border of the marginal border 106, according to one embodiment. According to various embodiments, the marginal border 106 may be folded along section BB to create a top marginal fold 202, as further indicated by section AA, and a bottom marginal fold 204, as further indicated by section BB.

FIG. 2B is a folded view 260 of the bedsheet component 100 of FIG. 1. Particularly, FIG. 2B builds on FIG. 1-2A, and further adds a top marginal fold 202 and a bottom marginal fold 204, according to one embodiment.

A top marginal fold 202 may be an uppermost bend of the bedsheet component 100. A bottom marginal fold 204 may be a lower bend of the bedsheet component 100, according to one embodiment. The top marginal fold 202 may lie over the bottom marginal fold 204. In another embodiment, the top marginal fold 202 is aligned to be substantially parallel with the bottom marginal fold 204, according to one embodiment.

Particularly, section AA further indicates a top marginal border of the marginal border 106, according to one embodiment. In addition, section BB indicates a bottom marginal border of the marginal border 106, according to one embodiment. According to various embodiments, the marginal border 106 may be folded along section BB to create the top marginal fold 202, as further indicated by section AA, and the bottom marginal fold 204, as further indicated by section BB.

FIG. 2C is a folded cross-section view 270 of the bedsheet component 100 of FIG. 1, according to one embodiment. Particularly, FIG. 2C builds on FIGS. 1-2B, and further includes an adhesive 206, a heat 208, a pressure 210, and a customized fusion machine 212, according to one embodiment. The adhesive 206 may be a substance used for sticking the fabric 102 temporary and/or permanently without sewing. The adhesive 206 may be a layer of freely flexible thermoplastic adhesive that is inserted between the top marginal fold 202 and the bottom marginal fold 204 for a joining operation. The adhesive 206 may permanently bond the top marginal fold 202 and the bottom marginal fold 204 when the adhesive 206 is cured, according to one embodiment.

The heat 208 and/or pressure 210 is applied sufficiently to the top marginal fold 202 and the bottom marginal fold 204 to soften the adhesive 206 (e.g., layer of freely flexible thermoplastic adhesive) and fuse the fabric 102 of FIG. 1 together. For example, steam may provide both the heat 208 and/or the pressure 210 to the area being pressed. The heat 208 may be applied by steam, gas, and/or electrical resistance, according to one embodiment.

The customized fusion machine 212 may be used to bond the top marginal fold 202 and the bottom marginal fold 204 of the marginal border 106. The marginal border 106 may be bonded flat, clean and less susceptible to wrinkling after pressing by the customized fusion machine 212. In another embodiment, the customized fusion machine 212 may be equipped with a pair of rotating wheels that applies the heat 208 and/or the pressure 210 on the top marginal fold 202 and the bottom marginal fold 204 as the fabric 102 passes between them. In another embodiment, the customized fusion machine 212 may eliminate any sort of corrugation. In circle ‘1’, the heat 208 and/or the pressure 210 is applied by the customized fusion machine 212 to the top marginal fold 202 and/or bottom marginal fold 204, according to one embodiment.

FIG. 2C further illustrates section AA indicating a top marginal border of the marginal border 106, according to one embodiment. In addition, section BB indicates a bottom marginal border of the marginal border 106, according to one embodiment. According to various embodiments, the marginal border 106 may be folded along section BB to create the top marginal fold 202, as further indicated by section AA, and the bottom marginal fold 204, as further indicated by section BB.

FIG. 2D is a permeation view 280 of the bedsheet component 100 of FIG. 1, according to one embodiment. Particularly, FIG. 2D builds on FIGS. 1-2C, and further adds a portion of the top marginal fold 214, a portion of the bottom marginal fold 216, and a single and complete flexible unit 218, according to one embodiment. The portion of the top marginal fold 214 may be a part of the top marginal fold 202. The portion of the bottom marginal fold 216 may be a part of the bottom marginal fold 204. The adhesive 206 may permeate the portion of the top marginal fold 214 and the portion of the bottom marginal fold 216, holding the top marginal fold 202 and the bottom marginal fold 204 together as the single and complete flexible unit 218. The single and complete flexible unit 218 may have an unencumbered continuous smooth texture, according to one embodiment.

FIG. 3 is a perspective view 350 of the bedsheet component 100 of FIG. 1, illustrating the dimensions of the fabric 102 and conventional mattress 308, according to one embodiment. Particularly, FIG. 3 builds on FIG. 1, and further adds a fabric length 300, fabric width 302, a mattress length 304, a mattress width 306, and a conventional mattress 308, according to one embodiment.

The fabric length 300 may be an extended dimension, highest measurement, and/or longest dimension of the fabric 102 of FIG. 1. The fabric width 302 may be the linear extent and/or shortest dimension as opposed to the fabric length 300. The mattress length 304 may be an extended dimension, highest measurement, and/or a longest dimension of the mattress (e.g., the conventional mattress 308) that is heavily filled with soft material or an arrangement of coiled springs, used as or on a bed, according to one embodiment.

The mattress width 306 may be the linear extent and/or shortest dimension as opposed to the mattress length 304. The conventional mattress 308 may be a rectangular pad of heavy cloth filled with soft materials. In another embodiment, the conventional mattress 308 may be large flat pad with a strong cover, filled with straw, and/or foam rubber. In another embodiment, the conventional mattress 308 may be a part of a bed, made of a strong cloth cover filled with firm material.

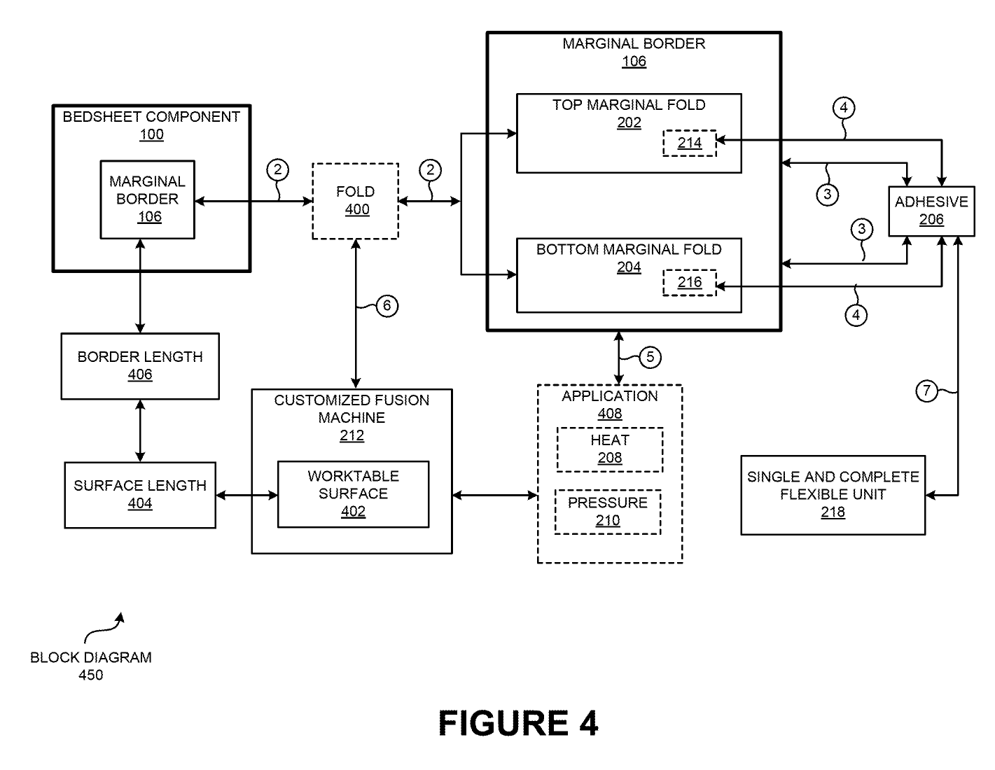

FIG. 4 is a block diagram 450 illustrating the formation of a single and complete flexible unit 218, according to one embodiment. Particularly, FIG. 4 builds on FIGS. 1-2D, and further adds a fold 400, a worktable surface 402, a surface length 404, a border length 406, and an application 408, according to one embodiment.

The fold 400 may include bending the top marginal fold 202 over the bottom marginal fold 204 of the marginal border 106 of FIG. 1 by the customized fusion machine 212 of FIG. 2C. The worktable surface 402 may be a flat platform. The marginal border 106 of FIG. 1 may fit flatly on the worktable surface 402. The surface length 404 may be the extended dimension, highest measurement, and/or a longest dimension of worktable surface 402.

The surface length 404 is substantially compatible with a border length 406 of the marginal border 106 of FIG. 1, according to one embodiment. The border length 406 may be the longest dimension of the marginal border 106 of FIG. 1. The application 408 may include applying the heat 208 and/or pressure 210 to the top marginal fold 202 and/or the bottom marginal fold 204 of FIG. 2B-2C, according to one embodiment.

FIG. 4 illustrates the bedsheet component 100 constituting the marginal border 106 of FIG. 1. In circle ‘2’, the marginal border 106 is folded to form the top marginal fold 202 and the bottom marginal fold 204, according to one embodiment. In circle ‘3’, an adhesive 206 is inserted between the top marginal fold 202 and the bottom marginal fold 204 of FIG. 2B. In circle ‘4’, the adhesive 206 permeates a portion of the top marginal fold 214 and a portion of the bottom marginal fold 216.

In circle ‘5’, a heat 208 and/or a pressure 210 is applied to the top marginal fold 202 and/or a bottom marginal fold 204 of the marginal border 106, according to one embodiment by the customized fusion machine 212. In circle ‘6’, the marginal border 106 is folded by the customized fusion machine 212 that has a worktable surface 402. The worktable surface 402 has a surface length 404 compatible with the border length 406 of the marginal border 106. In circle ‘7’, the top marginal fold 202 and the bottom marginal fold 204 are held together as a single and complete flexible unit 218 when the adhesive 206 of FIG. 2D (e.g., layer of freely flexible thermoplastic adhesive) is cured, according to one embodiment.

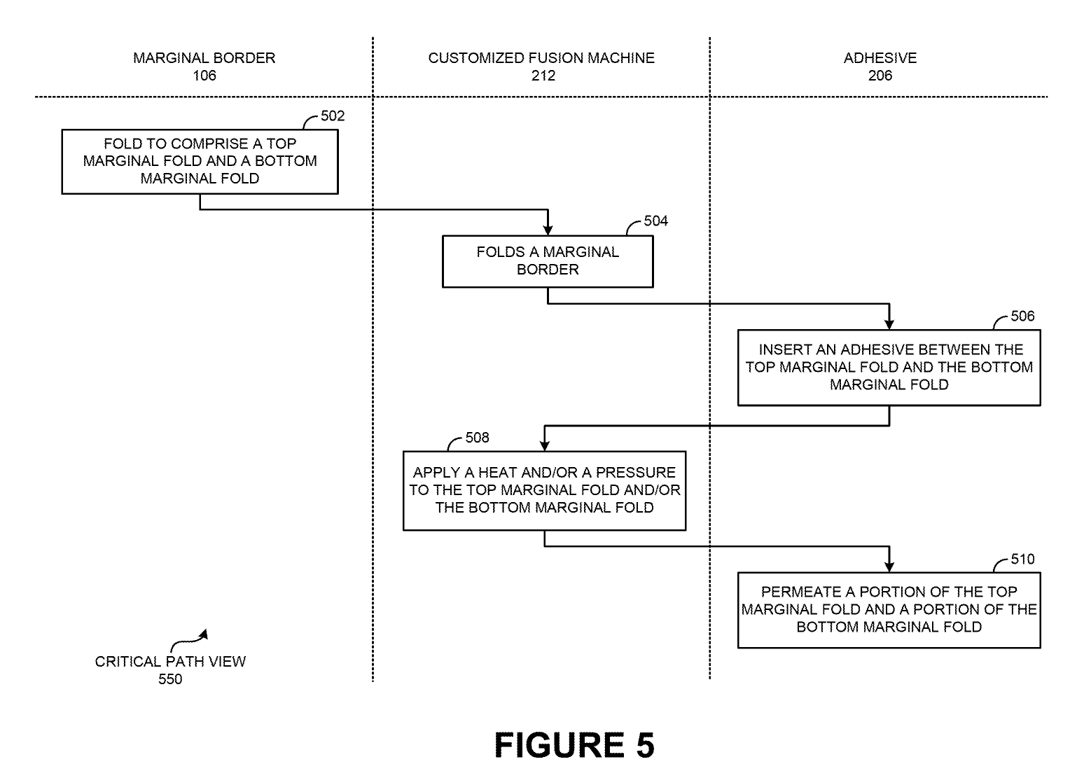

FIG. 5 is a critical path view 550 illustrating a flow where the adhesive 206 (e.g., layer of freely flexible thermoplastic adhesive) permeates a portion of the top marginal fold 214 and a portion of the bottom marginal fold 216 of FIG. 2D, according to one embodiment. In operation 502, a marginal border 106 of FIG. 1 is folded to include a top marginal fold 202 and a bottom marginal fold 204.

In operation 504, the marginal border 106 may be folded by a customized fusion machine 212, according to one embodiment. In operation 506, an adhesive 206 (e.g., layer of freely flexible thermoplastic adhesive) is inserted between the top marginal fold 202 and a bottom marginal fold 204. In operation 508, a heat 208 and/or a pressure 210 may be applied to the top marginal fold 202 and a bottom marginal fold 204 by the customized fusion machine 212. In operation 510, the adhesive 206 permeates the portion of the top marginal fold 214 and the portion of the bottom marginal fold 216, according to one embodiment.

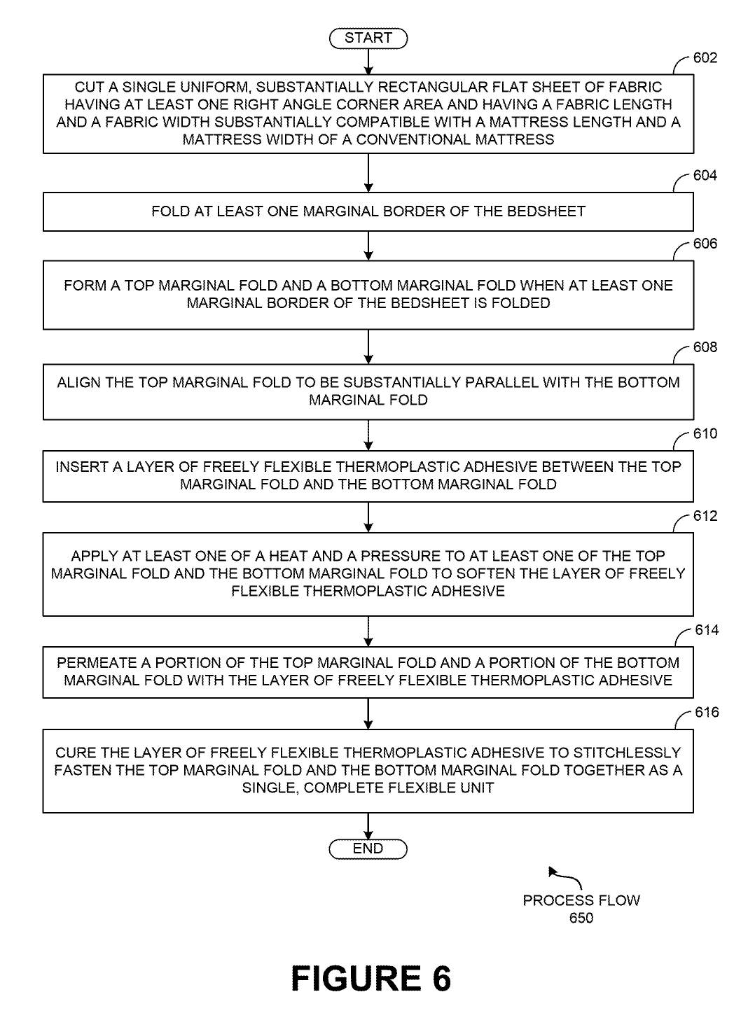

FIG. 6 is a process flow 650 detailing the operations involved in fabricating a bedsheet component 100 of FIG. 1, according to one embodiment. In operation 602, a single uniform, substantially rectangular flat sheet of fabric 102 having the right angle corner area (e.g., angled corner area 104) and having a fabric length 300 and a fabric width 302 substantially compatible with a mattress length 304 and a mattress width 306 of a conventional mattress 308 are cut.

In operation 604, the marginal border 106 of the bedsheet component 100 is folded. In operation 606, a top marginal fold 202 and a bottom marginal fold 204 are formed when the marginal border 106 of the bedsheet component 100 of FIG. 1 is folded, according to one embodiment. In operation 608, the top marginal fold 202 is aligned to be substantially parallel with the bottom marginal fold 204. In operation 610, a layer of freely flexible thermoplastic adhesive (e.g., adhesive 206) is inserted between the top marginal fold 202 and the bottom marginal fold 204 of FIG. 2B, according to one embodiment.

In operation 612, the heat 208 and/or the pressure 210 is applied to the top marginal fold 202 and the bottom marginal fold 204 to soften the layer of freely flexible thermoplastic adhesive (e.g., adhesive 206). In operation 614, a portion of the top marginal fold 214 and a portion of the bottom marginal fold 216 are permeated with the layer of freely flexible thermoplastic adhesive (e.g., adhesive 206). In operation 616, the layer of freely flexible thermoplastic adhesive (e.g., adhesive 206) is cured to stitchlessly fasten the top marginal fold 202 and the bottom marginal fold 204 together as a single and complete flexible unit 218 of FIG. 2D.

An example embodiment will now be described. Sofia may be a housewife who manages her household affairs, and carry out the housework. In the spring time, Sofia may follow a practice of thoroughly cleaning her house that may include cleaning, dusting, and/or washing bed clothing. Sofia may find that every time she takes her bedsheet out for cleaning purpose, the threaded portion tears apart due to factors such as: over-exposure of the bedsheets to sunlight for a long time, frequently washing and/or dry-cleaning the bedsheets which may weaken the fibers, and/or daily use of the bedsheets on mattresses in her household. She may find that repairing and/or resewing the heavy bedsheets may be a laborious job. Sofia may realize that even taking the bedsheet to a professional sewer may be burdensome and/or may require high maintenance. Sofia may also find that purchasing new bedsheets on a regular basis requires a high cost.

Sofia may also find that the bedsheets often pucker and form unsightly gathered areas in the sections that are stitched. Sofia may find these areas unsightly and/or uncomfortable to sleep in. Sofia may wish for a more smooth texture in her bedsheets that will be more visually appealing and more comfortable.

Thankfully, Sofia may learn about the new stitchless bedsheets (as described in FIGS. 1-6) from one of her friends. Sofia may decide to invest money in buying the new stitchless bedsheets instead of wasting money in repairing her old bedsheets and/or frequently replacing them. On using the new stitchless bedsheets, Sofia may learn that the new stitchless bedsheets hardly requires any maintenance and can be used conveniently and for a substantially longer duration of time. Furthermore, Sofia may realize that the new stitchless bedsheet eliminate the problems of creases, formation of uncomfortable lumps, fabric shrinkage, bubbling, and/or other distortions in the bedsheet. Even the family members of Sofia may notice and appreciate the visual appearance of the bedsheets in their house. Sofia may now recommend the new stitchless bedsheets to her other friends and relatives.

Another example embodiment will now be described. Donna may be a maid employed in ‘Hotel Blue’ located in California. As a chambermaid, Donna's duties may include, changing and/or arranging bedding, vacuuming floors, wiping down surfaces, etc. Donna may find it challenging to clean and/or change the stitched bedsheets. While dusting, cleaning and/or changing the bedsheets in the hotel rooms, Donna may realize that the stitched bedsheets rip easily with time in the areas where they are stitched and may cause problem to the hotel guests. Donna may also receive complaints from guests from time to time when a hotel guest finds a portion of a needle in their bedsheets and gets injured as a result. Out of concern, Donna may approach the housekeeper manager of ‘Hotel Blue’. The housekeeper manager may consult a few shopkeepers in the market who sell high quality and/or tear resistant bedsheets.

Thankfully, the housekeeper manager may learn about the new stitchless bedsheets (as described in the FIGS. 1-6) from one of the shopkeepers, who also informs him that there will be no risk of stray needles being accidentally left in the bedsheets. The housekeeper manager may try to implement the new stitchless bedsheets in the hotel rooms. Now, the housekeeper manager may not receive any complaints from maids and/or hotel guests.

In another example embodiment, ‘International Textiles’ located in Florida may be a leading supplier of bedsheets. The owner of ‘International Textiles’ may experience that consumers often complain about the tearing of the stitched bedsheets, weakening of the fiber due to laundering and/or exposure of the bedsheets over time, and/or being injured by needles left in the bedsheets. The owner may feel that his business may get affected in future because of the increasing complaints received from the consumers. The owner may search for an alternative to solve these problems and/or attract more consumers.

Thankfully, one day the owner of ‘International Textiles’ may learn about the new stitchless bedsheets (as described in FIGS. 1-6). The owner of ‘International Textiles’ may decide to sell the stitchless bedsheets and review the response of consumers for a month. The owner of the shop may experience an over whelming response from the consumers. He may notice that consumers are attracted towards the new stitchless bedsheet that is tear resistant and/or durable and that do not carry a risk of stray needles in the bedsheets. The owner of ‘International Textiles’ may now decide to continue selling the stitchless bedsheets looking at the positive response from the buyers.

A number of embodiments have been described. Nevertheless, it will be understood that various modifications may be made without departing from the spirit and scope of the claimed invention. Accordingly, other embodiments are within the scope of the following claims.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A bedsheet component comprising:
a fabric having at least one angled corner area;
at least one marginal border,
wherein the at least one marginal border is folded to further comprise a top marginal fold and a bottom marginal fold, and
wherein the top marginal fold is aligned to be substantially parallel with the bottom marginal fold; and
an adhesive inserted between the top marginal fold and the bottom marginal fold,
wherein an application of at least one of a heat and a pressure to at least one of the top marginal fold and the bottom marginal fold to soften the adhesive, and
wherein the adhesive further to permeate a portion of the top marginal fold and a portion of the bottom marginal fold, holding the top marginal fold and the bottom marginal fold together as a single, complete flexible unit when the adhesive is cured.

2. The bedsheet component of claim 1, wherein the fabric has a fabric length and a fabric width substantially compatible with a mattress length and a mattress width of a conventional mattress.

3. The bedsheet component of claim 1, wherein the fabric is any one of a fitted sheet, a flat sheet, and a pillowcase.

4. The bedsheet component of claim 1, wherein the at least one marginal border of the bedsheet component is stitchlessly fastened together through the adhesive when the adhesive is applied in the portion of the top marginal fold and the portion of the bottom marginal fold and the adhesive is cured.

5. The bedsheet component of claim 1, wherein the adhesive is a layer of freely flexible thermoplastic adhesive.

6. The bedsheet component of claim 1:
wherein the folding of the at least one marginal border is by a customized fusion machine
wherein the customized fusion machine has a worktable surface,
wherein the worktable surface has a surface length substantially compatible with a border length of the at least one marginal border, and
wherein the at least one marginal border fits flatly on the worktable surface.

7. The bedsheet component of claim 1:
wherein the application of at least one of the heat and the pressure to at least one of the top marginal fold and the bottom marginal fold is by a customized fusion machine,
wherein the customized fusion machine has a worktable surface,
wherein the worktable surface has a surface length substantially compatible with a border length of the at least one marginal border, and
wherein the at least one marginal border fits flatly on the worktable surface.

8. The bedsheet component of claim 1:
wherein the folding of the at least one marginal border and the application of at least one of the heat and the pressure to at least one of the top marginal fold and the bottom marginal fold is by a customized fusion machine,
wherein the customized fusion machine has a worktable surface,
wherein the worktable surface has a surface length substantially compatible with a border length of the at least one marginal border, and
wherein the at least one marginal border fits flatly on the worktable surface.

9. The bedsheet component of claim 1, wherein the single, complete flexible unit is an unencumbered continuous smooth texture.

10. The bedsheet component of claim 1, wherein the adhesive permanently bonds the top marginal fold and the bottom marginal fold when the adhesive is cured.

11. A bedsheet component comprising:
a single uniform, substantially rectangular flat sheet of fabric having at least one right angle corner area and having a fabric length and a fabric width substantially compatible with a mattress length and a mattress width of a conventional mattress;
at least one marginal border,
wherein the at least one marginal border is folded to further comprise a top marginal fold and a bottom marginal fold, and
wherein the top marginal fold is aligned to be substantially parallel with the bottom marginal fold; and
a layer of freely flexible thermoplastic adhesive inserted between the top marginal fold and the bottom marginal fold,
wherein an application of at least one of a heat and a pressure to at least one of the top marginal fold and the bottom marginal fold to soften the layer of freely flexible thermoplastic adhesive,
wherein the layer of freely flexible thermoplastic adhesive further to permeate a portion of the top marginal fold and a portion of the bottom marginal fold, holding the top marginal fold and the bottom marginal fold together as a single, complete flexible unit when the layer of freely flexible thermoplastic adhesive is cured, and
wherein the at least one marginal border of the bedsheet is stitchlessly fastened together through the layer of freely flexible thermoplastic adhesive when the layer of freely flexible thermoplastic adhesive is applied in the portion of the top marginal fold and the portion of the bottom marginal fold and is cured.

12. The bedsheet component of claim 11:
wherein the folding of the at least one marginal border is by a customized fusion machine
wherein the customized fusion machine has a worktable surface,
wherein the worktable surface has a surface length substantially compatible with a border length of at least one marginal border, and
wherein the at least one marginal border fits flatly on the worktable surface.

13. The bedsheet component of claim 11:
wherein the application of at least one of the heat and the pressure to at least one of the top marginal fold and the bottom marginal fold is by a customized fusion machine,
wherein the customized fusion machine has a worktable surface,
wherein the worktable surface has a surface length substantially compatible with a border length of at least one marginal border, and
wherein the at least one marginal border fits flatly on the worktable surface.

14. The bedsheet component of claim 11:
wherein the folding of the at least one marginal border and the application of at least one of the heat and the pressure to at least one of the top marginal fold and the bottom marginal fold is by a customized fusion machine,
wherein the customized fusion machine has a worktable surface,
wherein the worktable surface has a surface length substantially compatible with a border length of at least one marginal border, and
wherein the at least one marginal border fits flatly on the worktable surface.

15. The bedsheet component of claim 11, wherein the single, complete flexible unit is an unencumbered continuous smooth texture.

16. The bedsheet component of claim 11, wherein the layer of freely flexible thermoplastic adhesive permanently bonds the top marginal fold and the bottom marginal fold when the layer of freely flexible thermoplastic adhesive is cured.

17. A method of fabricating a bedsheet component comprising:
cutting a single uniform, substantially rectangular flat sheet of fabric having at least one right angle corner area and having a fabric length and a fabric width substantially compatible with a mattress length and a mattress width of a conventional mattress;
folding at least one marginal border of the bedsheet;
forming a top marginal fold and a bottom marginal fold when at least one marginal border of the bedsheet is folded;
aligning the top marginal fold to be substantially parallel with the bottom marginal fold;
inserting a layer of freely flexible thermoplastic adhesive between the top marginal fold and the bottom marginal fold;
applying at least one of a heat and a pressure to at least one of the top marginal fold and the bottom marginal fold to soften the layer of freely flexible thermoplastic adhesive;
permeating a portion of the top marginal fold and a portion of the bottom marginal fold with the layer of freely flexible thermoplastic adhesive; and
curing the layer of freely flexible thermoplastic adhesive to stitchlessly fasten the top marginal fold and the bottom marginal fold together as a single, complete flexible unit.

18. The method of fabricating the bedsheet component of claim 17, further comprising stitchlessly fastening together the at least one marginal border of the bedsheet through the layer of freely flexible thermoplastic adhesive when the layer of freely flexible thermoplastic adhesive is applied in the portion of the top marginal fold and the portion of the bottom marginal fold and the layer of freely flexible thermoplastic adhesive is cured.

19. The method of fabricating the bedsheet component of claim 17:
wherein the folding of the at least one marginal border and an application of at least one of the heat and the pressure to at least one of the top marginal fold and the bottom marginal fold is by a customized fusion machine,
wherein the customized fusion machine has a worktable surface,
wherein the worktable surface has a surface length substantially compatible with a border length of at least one marginal border, and
wherein the at least one marginal border fits flatly on the worktable surface.

20. The bedsheet component of claim 17, wherein the single, complete flexible unit is an unencumbered continuous smooth texture.
